(19) United States
(12) Patent Application Publication
(10) Pub. No.: US 2013/0319939 A1
(43) Pub. Date: Dec. 5, 2013

(54) Modular Precipitation and Oxidized Water Treatment

(71) Applicant: Concord Produced Water Services, LLC, Denver, CO (US)

(72) Inventor: David Bower, Bennett, CO (US)

(73) Assignee: Concord Produced Water Services, LLC

(21) Appl. No.: 13/905,414

(22) Filed: May 30, 2013

Related U.S. Application Data
(60) Provisional application No. 61/654,220, filed on Jun. 1, 2012.

(51) Int. Cl. C02F 1/52

(52) U.S. Cl. CPC C02F 1/5236
USPC 210/620; 210/207; 210/202; 210/150; 210/721

(57) ABSTRACT

A modular system for reclamation of a fluid includes a cavitation reactor operative to mechanically oxide the fluid and an ion precipitation system that receives the oxidized fluid from the cavitation reactor and thereafter introduces one or more ions at various locations to initiate precipitation of select materials. The system and associated methodology further includes injecting dissolved air and emulsion breaking chemistry into the fluid before cavitation, coalescing emulsified particulates from the fluid and saturating the fluid in an air saturation chamber that is operable to form a microbial filter.

### RELATED APPLICATION

The present application relates to and claims the benefit of priority to U.S. Provisional Patent Application No. 61/654,220 filed 1 Jun. 2012, which is hereby incorporated by reference in its entirety for all purposes as if fully set forth herein

### BACKGROUND OF THE INVENTION

1. Field of the Invention

Embodiments of the present invention relate, in general, to water treatment and more particularly to a modular and mobile unit for reclaiming wastewater from oil and gas exploration operations.

2. Relevant Background

In 1858 Edwin Drake successfully drilled a shallow crude oil well in Pennsylvania marking the beginning of one of man's greatest period of economic growth. This growth was largely driven by the rapid strides that were made in the exploration, production, and refining, of naturally occurring gaseous and liquid hydrocarbon compounds, commonly known as oil. The birth and development of what we now call “the Oil Industry” is one of the major principal factors and enabling driving forces contributing to the establishment and spectacular growth in the world's economy.

During this period, many new oil fields were discovered in many parts of the world and the growth in the demand for crude oil and petroleum products grew at a fantastic rate due to the many new uses for petroleum-derived products that continued to be discovered well into the Twenty-first Century. Throughout this period the Oil Industry found many oil new fields or large deposits or reservoirs of conventionally varying hydrocarbon mixtures of liquid and gaseous compounds (both on land and offshore in the various bodies of water throughout the world). At the same time, the Industry also discovered the existence of large quantities of heavy and light hydrocarbon compound mixtures that were nonconventional in structure and were so enmeshed in the complex material matrixes that the hydrocarbon molecule compounds contained therein could not be extracted economically.

These nonconventional hydrocarbon compound sources fall into two distinctly different categories. First there are the “heavy” or long-chain hydrocarbon molecule compounds such as the oil sands deposits in Canada and the heavy oil deposits in the Kern River or Bellridge regions of California. In such locations the heavy oil produced is extremely viscous and is in a semisolid state at ambient temperatures. Second there are the “light” or “short-chain” hydrocarbon molecule compounds that are entrapped in various shale deposits throughout the United States and in many other areas in the world. The extraction of both types presented a challenge to the oil industry and a world economy thirsty for its product.

In the United States, there are many areas where oil shale rock deposits are to be found, but most of them are located as deep deposits five to ten thousand feet below the surface of the earth. As early as before the nineteen twenties, many attempts made to mine or extract the kerogen oil from stratified shale formations. Although the shale oil proved to be a very suitable hydrocarbon product, its cost of production was well more than the market price of similar products; thus this situation proved at that time to be uneconomical.

All of these factors and conditions have changed dramatically over the past years due, primarily, to the rapid development and exploitation of two specialized technologies. The first of these is the carefully controlled and steerable directional drilling techniques that allowed rigs to be able to initially drill vertically and then be controlled or steered to rotate into a horizontal position while drilling to a predetermined depth. The drilling could then continue to drill well bores horizontally in the shale formation for a considerable distance. The second most important technological development was the application of an old process, namely the practice of hydraulically fracturing older vertical oil wells to increase the flow rate as well as to promote the further stimulation of the older, oil wells and thereby extend the economic life of the depleting oil fields.

Over the years many different techniques were developed and implemented in an attempt to extend the productive life of older oil and more mature oil field fields. Water flooding was one of the practices that was employed to maintain reservoir pool pressure in depleting oil fields as well as the injection of pressurized methane gas (when available and not being flared) to achieve the same result.

Such methods for EOR (Enhanced Oil Recovery) were the oil industry norm for many years. However some oil companies were concerned about the dangers in using explosives as a means of extending the productive life of depleting oil fields; and, in the late nineteen forties, the practice of using highly pressured water and sand mixtures to produce fissures or fractures in the pay-zone areas began. This technique was developed to try to increase the rate of flow in the oil well and to extend the productive life of a mature and depleting oil field without the use of explosives. Opening new channels hydraulically in the older pay zones made it easier for the liquid and gaseous hydrocarbons to flow freely under bottom hole pressure up to the surface for collection as crude oil and gas products.

Also the practice of using work-over rigs to clean out old oil well casings that had restricted hydrocarbon flows due to the accumulation of asphaltic or paraffinic compounds was wide-spread during this period.

The use of all these types of oil well stimulation practices, as well as the use of other enhanced oil recovery techniques, continued over a long period of time and many improvements were developed over the years.

However, during the period when the application of hydraulic fracturing was becoming more wide spread, its growth, technologically and operationally, was carried out in a very haphazard, hit and miss, ad hoc manner. Many of the improvements that were made were the result of unscientifically developed trial and error attempts to improve the rate of production in an oil well as well as trying to extend the economic life of established oil fields. This was all done without the benefit of fully examining or understanding the sound scientific reasons behind the need for those improvements.

It was not until the industry started to realize that the traditional principles of petroleum technology were not fully applicable to the newly developed attempts to extract entrapped liquid and gaseous hydrocarbons from mineral rock formations that did allow them to flow freely even in deep high temperature and high pressure locations. Petroleum engineers then turned to the principles of applying the examination of hard rock mechanics of minerals geology criteria in seeking a comprehensive analysis and understandable answer to these issues.

The ability to accurately determine the true mineral characteristics of an oil shale is very important in selecting the best operational techniques that are needed to optimize or maximize the ultimate recovery of hydrocarbon components from a specific shale formation or deposit. Soft oil shale formations respond differently from hard oil shale formations after both have been subjected to the same level of hydraulic water pressure for the same soaking time. Hard oil shales, under high hydraulic pressures yield fissures or channels that are relatively short in penetration length and rather small in the cross sectional diameters of their fissures or flow channels. Soft oil shales, on the other hand, under the same high hydraulic pressure and soaking period yield fissures that are of greater length and have cross sectional diameters that are relatively larger than what can be achieved from the hydraulic fracturing of materials in the hard oil shale formations.

As a result of the rapid increase in the extent and amount of hydraulic fracturing of oil shale deposits being developed in a number of different areas in the United States, there has arisen a number of ecological and environmental concerns that must be addressed if the industry is to grow successfully. For instance toxic chemicals (such as glutaraldehyde) are used as a biocide to kill, control, or eliminate, the water borne microorganisms that are present in the water used in the hydraulic fracturing process. There is great concern such toxic chemical-bearing fracturing water could migrate into a potable water aquifer. Also of concern is the possibility of friction-reducing chemicals (e.g., polyacrylamide) or scale inhibitors (e.g., phosphonate) finding their way into and contaminating an aquifer. Detergent soap mixtures as well as chemicals such as potassium chloride are commonly used as surface-tension-reducing surfactants and could create public health issues. The current practice of injecting brine-contaminated flow-back water into disposal wells is another of concern to the public.

In some examples of traditional fracturing jobs, after explosively perforating a horizontal well casing, a water mixture is injected at high pressure into a multitude of individually sequenced fracturing zones, each being sealed off at both ends by packer sleeves. This allows the water mixture to remain in the shale formation under pressure for several days, creating channels, fractures, or fissures which, when the hydraulic pressure is released by a coiled drilling operation, allow hydrocarbon gas and liquid elements to have passageways that allow flow to the surface. For each individual fracturing zone, the pressure in the water mixture is reduced in sequence so that the depressurized water flows back horizontally into the well bore and then continues upward in the vertical cemented well section to the ground surface elevation.

The flow-back water volume accounts for less than fifty percent of the amount of injected water used for the fracturing operation. The flow-back water stream also contains materials that are leached out of the shale formation such as bicarbonates, (e.g., nacolities). The flow-back water mixture also carries with it many volatile organic compounds as well as the microorganism debris, any dissolved salts or brines, and a significant amount of the initially-injected proppant and their produced fines. Treatment and/or disposal of this flow-back are significant issues for the industry.

Currently, it is common practice to kill microorganisms that are in the water mixture, either initially or insitu, by chemical or other types of biocides so that the gaseous and liquid hydrocarbons that are trapped in the oil shale's matrix formation can flow freely into the channels and fissures vacated by the flow-back water mixture. Also, the channels created by the fracturing process must be kept open by proppants that are initially carried into the fissures in the fracture zones by the injected water mixture. If the microorganisms are not killed they will multiply, rapidly; and, if they remain in the fissures, they will grow and reduce or entirely block the flow hydrocarbons from these fissures. Another significant microorganism type problem is the possible presence of a strain of microbes that have an affinity for seeking out digesting any free sulfur or sulfur bearing compounds and producing hydrogen sulfides that must be removed from any product gas stream because it is a highly dangerous and carcinogenic material. All these types of microorganisms must be destroyed if this type of problem is to be avoided.

Along with the possibility of microorganisms multiplying and blocking the flow of hydrocarbon product, the presence of dissolved solids in the water solution can also be a problem in the injected water mixture, they can deposit themselves as scale or encrustations in the same flow channels and fissures. These encrustations, if allowed to be deposited in these channels, will also reduce or block the flow of hydrocarbons to the surface. To avoid this condition, attempts are made in current industry practice to have the dissolved solids coalesce and attach themselves to the suspended or other colloidal particles present in the water mixture to be removed before injection in the well; however, those efforts are only partly effective.

In recent years, the oil industry has tried to develop a number of ways to address these concerns. The use of ultra violet light in conjunction with reduced amounts of chemical biocide has proven to be only partially effective in killing water borne microorganisms. This is also true when also trying to use ultra-high frequency sound waves to kill microorganisms. Both these systems, however, lack the intensity and strength to effectively kill all of the water-borne microorganisms with only one weak short time residence exposure and with virtually no residual effectiveness. Both systems need some chemical biocides to effectively kill all the water borne microorganisms that are in water. Also, some companies use low-frequency or low-strength electromagnetic wave generators as biocide/coalescers; however, these too have proven to be only marginally effective.

Therefore, it is desirable to economically address and satisfactorily resolve some of the major environmental concerns that are of industry-wide importance. One challenge is that contaminated water produced by the current oil and gas exploration technology must either be transported from the site for treatment or disposal, or treated onsite. Currently onsite treatment is a temporary option and the expense for transport to a more permanent and effective solution is significant.

The aim of all water treatment is to achieve a higher standard of final water quality regardless of the quality of the source water. Water treatment as applied to the oil and gas industries is no different with one notable exception. That is location. In most instances of water treatment the treatment facility is located at the source of the water. In the oil and gas example location of the hydrocarbon, not the water drives this determination. Moreover, each input source is different. Some sources, such as water from rivers or water used in oil and gas exploration, require more extensive treatment than others. Ground water for example may be essentially pure based on a natural filtration process. But in cases in which the quality of the water is not acceptable several techniques can be used to reclaim water including, among other things, the use of coagulants. Coagulants can be classified into inorganic coagulants, synthetic organic polymer and naturally occurring coagulants. They are used for various purposes depending on their chemical characteristics.

Coagulation or chemical precipitation has been known since the previous century when it became widely used in England where lime was used as coagulant alone or with calcium chloride or magnesium. Removal of turbidity by coagulants however, depends on the type of colloids in suspension, pH, chemical composition of the water, the type of coagulant and coagulant aid, and the degree and time of mixing provided for chemical dispersion and floc formation.

There are two main mechanisms of coagulation: At a relatively high coagulant dosage and higher pH, there is an adsorption of particles onto a floc of, for example, aluminum hydroxide or ferric hydroxide, while the formation of insoluble complexes occurs in a way that is analogous to that of charge neutralization that predominates at low coagulation dosage and lower pH values.

In the coagulation process, coagulant chemicals are added to the water as it passes through the static or flash mixer. Primary coagulants are chemicals that are responsible for the main coagulation reactions, being the formation of floc and the neutralization of particle charges while aids are added later to facilitate that coagulation process.

All particles carry an electrical charge on their surface, which is usually negative, and thus, the particles tend to repel each other. Coagulation chemicals neutralize this charge so the particles can combine into large accumulations if they touch each other. The pH of the water is very important as it determines the charge of the chemicals in the reaction, and determines the solubility of the coagulant. Unfortunately, the chemicals by which this process is generated are expensive and dangerous. While coagulation as a reclamation process is important, it is not the only technology that has been employed to cleanse water.

Another process by which water is cleansed is through oxidation. Contaminants are generally oxidized by four different reagents: ozone, hydrogen peroxide, oxygen, and air, in precise, preprogrammed dosages, sequences, and combinations. These procedures may also be combined in some applications with UV irradiation and specific catalysts. This results in the development of hydroxyl radicals.

The oxidation procedure is particularly useful for cleaning biologically toxic or non-degradable materials such as aromatics, pesticides, petroleum constituents, and volatile organic compounds in waste water. The contaminant materials are converted to a large extent into stable inorganic compounds such as water, carbon dioxide and salts, i.e. they undergo mineralization. A well known example of oxidation is the use of Fenton's reagent.

Fenton's reagent is a solution of hydrogen peroxide and an iron catalyst that is used to oxidize contaminants or waste waters. Fenton's reagent can also be used to destroy organic compounds such as trichloroethylene (TCE) and tetrachloroethylene (PCE). In the Fenton process Ferrous Iron(II) is oxidized by hydrogen peroxide to ferric iron(III), a hydroxyl radical and a hydroxyl anion. Ferric iron(III) is then reduced back to iron(II), a peroxide radical and a proton by the same hydrogen peroxide (disproportionation).

In the net reaction, the presence of iron is truly catalytic and two molecules of hydrogen peroxide are converted into two hydroxyl radicals and water. The generated radicals then engage in secondary reactions. The exact mechanisms of the entire process is still debated. And while effective, Ferrous Iron(II) is expensive and can be volatile.

Processes that engage in coagulation and oxidation typically require a large facility constructed near the source of water to be treated. Such facilities require substantial capital investments and are normally designed to address a specific environment. As previously indicated the current combination of chemicals needed to perform such an operation are exceedingly volatile and caustic. What is needed therefore is a safe, modular and mobile water treatment system that can utilize advanced techniques such as coagulation and oxidation to reclaim water at different locations. These and other challenges of the prior art are addressed by one or more embodiments of the present invention.

### SUMMARY OF THE INVENTION

A modular system for reclamation of a fluid such as water includes a cavitation reactor that is operative to mechanically oxide the fluid and an ion precipitation system that receives the oxidized fluid from the cavitation reactor and thereafter introduces one or more ions at various locations to initiate precipitation of select materials.

The modular nature of the present invention enables the injection of ions and cavitational process to be modified based on the quality of the incoming fluid and the desired outcome. The present invention recognizes that the quality and content of the influent may be inconsistent and thus the reclamation process must dynamically adjust its processes based on the influents compositions. The present invention monitors the composition of the influent to adjust various parameters within the modular precipitation and oxidization system to achieve a desired effluent. According to one embodiment or the present invention the cavitation reactor and the ion precipitation system is augmented by an oxidation system than can inject dissolved air and emulsion breaking chemistry into the flow before cavitation. The system can also include a coalescing chamber that separates emulsified particles from the flow.

The invention can also include a dissolved air flotation system and an air saturation chamber. Each of these additional components acts to remove certain impurities to arrive at a desired effluent quality level.

According to another embodiment of the present invention a method for modular precipitation and oxidization treatment of a fluid includes receiving a flow of the fluid from a reservoir and thereafter driving the fluid though a cavitation reactor causing the fluid to cavitate and mechanically oxidize the fluid. The process continues by injecting into the fluid one or more ions at specific location along a serpentine series of pipes to initiate precipitation of select materials. Other processes contemplated by the present invention include coalescing emulsified particulates from the fluid and saturating the fluid in an air saturation chamber that is operable to form a microbial filter.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high level block diagram of a system for waste water reclamation according to one embodiment of the present invention;

FIG. 2 is a flowchart for reclaiming waste water using coagulation and oxidation according to one or more embodiments of the present invention; and

FIG. 3 presents a high level schematic of a module system for waste water reclamation according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Disclosed hereafter by way of example is an apparatus, and associated methodology, for the modular and mobile treatment of water using advanced oxidation and pseudo Fenton reagents, along with coagulation, cavitation and flocculation for the precipitation of cations and ions, to remove targeted metal and dissolved salts from water.

Embodiments of the present invention are herein described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents. For clarity the following descriptions of certain key terms are offered for consideration.

Coagulation refers to change or be changed from a liquid into a thickened mass: egg white coagulating when heated; blood clotting over the wound; gravy congealing as it cools; milk that had curdled; used pectin to jell the jam; jellied consommé; allowed the aspic to set. process of changing from a liquid to a gel or solid state by a series of chemical reactions, especially the process that results in the formation of a blood clot.

Oxidation is combination of a substance with oxygen. Alternatively it is a reaction in which the atoms in an element lose electrons and the valence of the element is correspondingly increased. For example, removing an electron from an iron atom having a valence of +2 changes the valence to +3. Oxidation is thus the loss of electrons or an increase in oxidation state by a molecule, atom, or ion. An oxidation process can refer to herein as a set of chemical treatment procedures designed to remove organic and inorganic materials in waste water by oxidation.

Turbid or turbidity refers to having sediment or foreign particles stirred up or suspended; muddy.

Precipitation is the formation of a solid in a solution or inside another solid during a chemical reaction or by diffusion in a solid. When the reaction occurs in a liquid, the solid formed is called the precipitate. The chemical that causes the solid to form is called the precipitant. Without sufficient force of gravity (settling) to bring the solid particles together, the precipitate remains in suspension. After sedimentation, especially when using a centrifuge to press it into a compact mass, the precipitate may be referred to as a pellet or cake. The precipitate-free liquid remaining above the solid is called the supernate or supernatant.

Flocculation is a process by which individual particles of a substance aggregate into clot-like masses or precipitate into small lumps. Flocculation occurs as a result of a chemical reaction between the particles of one substance (such as clay) and another substance, usually mineralized water. Generally it is the process of forming woolly cloud-like aggregations.

The sudden formation and collapse of low-pressure bubbles in liquids by means of mechanical forces, such as those resulting from rotation of a marine propeller is called cavitation. Cavitation is the formation (and collapse) of vapor-or gas-filled cavities in a flowing liquid when tensile stress is superimposed on the ambient pressure.

A hydroxyl radical, .HO, is the neutral form of the hydroxide ion (HO⁻). Hydroxyl radicals are highly reactive and consequently short-lived; however, they form an important part of radical chemistry. Most notably hydroxyl radicals are produced from the decomposition of hydroperoxides (ROHO) or, in atmospheric chemistry, by the reaction of excited atomic oxygen with water. Hydroxyl radicals are also produced during UV-light dissociation of H2O2 (suggested in 1879) and likely in Fenton chemistry, where trace amounts of reduced transition metals catalyze peroxide-mediated oxidations of organic compounds.

The hydroxyl radical is often referred to as a “detergent” because it reacts with many pollutants, often acting as the first step to their removal. The rate of reaction with the hydroxyl radical often determines how long many pollutants last in an environment.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a, “an,” and “the” are intended to include the plural forms as well, unless the context clearly indicates otherwise. Thus, for example, reference to “a component surface” includes reference to one or more of such surfaces.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on”, “attached” to, “connected” to, “coupled” with, “contacting,” “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

According to one embodiment of the present invention, a modular mobile waste water treatment system comprises, among other things, a control unit, a wet module, a filtration module, a cavitation module, a biological module, a non-chemical/physical treatment module, an emission module and a storage module. These modules are each contained in mobile, modular components that can be quickly and efficiently transported to a site for implementation. Moreover each module employs new techniques for coagulation, oxidation and filtration to provide a safe and effective treatment system for the reclamation of water.

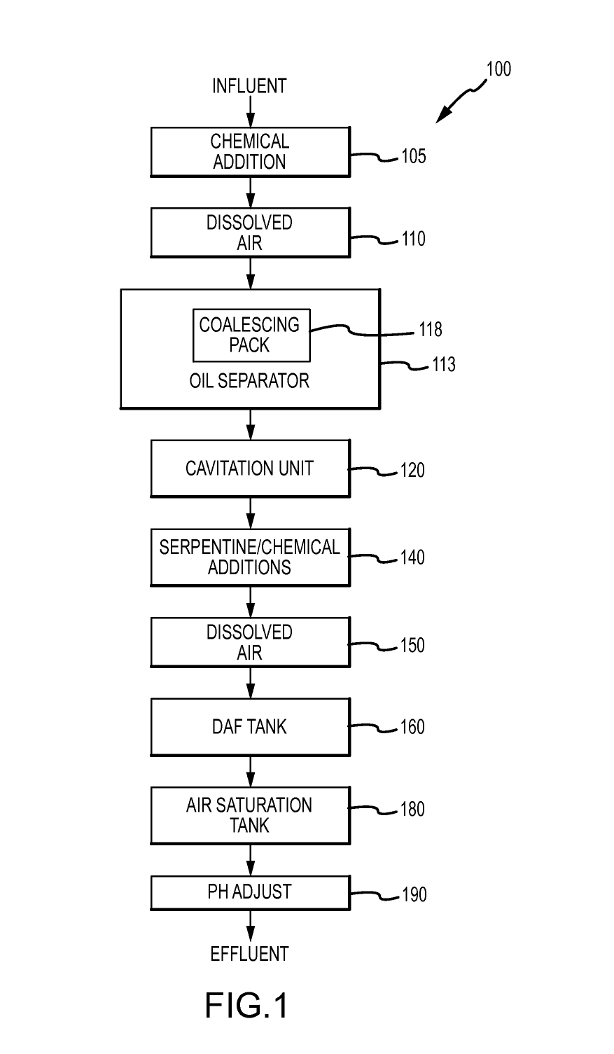

A system, according to one embodiment of the present invention, for water reclamation and purification, as can be seen generally in FIG. 1, begins with waste water being piped to a control unit from the individual or multiple reclamation tanks The control unit (not shown) serves to manage the collection and flow of the water into the reclamation system 100. As one of reasonable skill in the relevant art can appreciate, the source of the water needing treatment can vary and is not deemed to be restrictive as to the application of the invention. The water, once arrived from a dosing pump, is first transferred to an oxidation and emulsion breaking system 112. Within this system dissolved air 110 is injected into the flow as well as select chemicals 105 that can induce the breakdown of emulsified particles. Moreover certain chemical reactions occur creating hydroxyl radicals which can foster further purification processes. When the influent contains dense emulsions or sediments an externally obtained or internally manufactured emulsion breaker can be entrained into the influent flow before delivery to a coalescing chamber. A variety of oxidizing agents may be used. In one example, the oxidizing agents may include one or more of, a gas, a vapor, and a liquid. In one example, the oxidizing agents may include one or more of, hydrogen peroxide, peroxide salts, potassium permanganate, active oxygen, ozone, and others.

The flow thereafter flows to an oil and water separator 113 for what is referred to herein as wet screening. The separator has, in one embodiment of the present invention, an inlet chamber, coalescing chamber or coalescing pack 118 and outlet weir that maintains the water level. The separator 113 further includes a skimming weir to direct floatable substances to an oil/condensate discharge pump for later disposal or reuse.

The coalescing media in the coalescing chamber is, in one embodiment, a honeycomb of materials designed to increase the surface area of the chamber to maximize separation of oily or similar types of substances. Other coalescing substances and techniques can be used without departing from the scope of the present invention and their use is so contemplated. In connection with the coalescing chamber a recycle pump cycles additional water from the discharge chamber (described hereafter) to add dissolved air into the influent flow and enhance emulsion and floatation of oily (low density) type substances. This effectively multiplies the surface area within the coalescing media further and enhances floatation and separation of such substances at lower temperature ranges.

Inflow from the coalescing chamber 118 exits through a cross flow through the coalescing media to the discharge chamber and over a weir gate. The weir gate is used for maintaining influent level in the separator 113 and for collection of floatable substances as well as for the prevention of these substances exiting into the serpentine pump which can have a detrimental affect the precipitation chemistry within the serpentine system 120.

With primary screening complete the water is withdrawn from the oil/water separator tank 113 and discharged into a cavitation unit 120. In one embodiment of the present invention, the oxidation of the water (generation of hydroxyl radicals) can be accomplished mechanically rather than through the use of chemicals. By using hydrodynamic cavitation the objectives of impurity removal can be accomplished.

As fluid passes through the cavitation unit 120 it undergoes chemical and physical changes. Significantly the water can be cleaned or disinfected or otherwise purified by action of the cavitation. In a specific application, micro organisms, germs, bacteria, fungus, algae, or other live pests can be neutralized, killed, or removed from the water stream.

For example cavitation bubbles can be associated with the oxidizing agents. Collapse of the cavitation bubbles produces pulses of ultraviolet light, thereby ionizing the oxidizing agents, producing hydroxyl radicals, and degrading and/or oxidizing the organic substances in the fluid. In one embodiment a cavitation reactor may include a flow-through chamber including a local constriction of flow, a port configured to introduce oxidizing agents into the local constriction of flow, and an area configured to collapse the cavitation bubbles, thereby initiating events leading to degradation and/or oxidation of organic substances in a fluid flowed through the device.

As previously mentioned, collapse of the cavitation bubbles can produce ultraviolet oxidation of organic substances in the fluid. In one example, collapsing the cavitation bubbles can produce ultraviolet light or ultraviolet radiation as well as other high energy conditions such as shearing, high pressure, heat, mechanical vibration, noise, and possibly other local energy conditions. These localized high energy conditions facilitate breakdown of the organic substances. In one example, the ultraviolet light may facilitate one or more of, breakage of chemical bonds, activation and/or ionization of oxidizing agents, production of hydroxyl radicals, and oxidation or partial oxidation of the organic substances.

Introducing oxidizing agents into the fluid in can result in a relatively high local concentration of the oxidizing agents in the fluid as the fluid is in the process of forming cavitation bubbles. This results in production of cavitation bubbles that contain and/or are associated with concentrations of oxidizing agents sufficient to produce levels of hydroxyl radicals that may degrade and/or oxidize organic compounds in the fluid when the cavitation bubbles collapse.

Collapsing the cavitation bubbles can also produce localized high energy conditions like high pressures, high temperatures, and others. When gases are heated to high temperatures, as may happen to gases within cavitation bubbles when the cavitation bubbles collapse, plasmas may be created. The plasmas may emit ultraviolet light. The ultraviolet light may be emitted as pulses. Emission of this ultraviolet light may be called cavitation luminescence. The ultraviolet light may irradiate oxidizing agents contained within and/or associated with the cavitation bubbles. Irradiating oxidizing agents may produce ionization of the oxidizing agents. Thus irradiating oxidizing agents may produce hydroxyl radicals that can contact and/or react with organic compounds in a fluid or solution in which the cavitation bubbles are produced. These reactions can destroy or degrade the organic compounds, through breakage of chemical bonds within the compounds.

Upon exit from the cavitation unit 120 the flow enters a serpentine network of pipes 140. The serpentine itself is a high capacity mixing and dosing system designed to provide a definitive period-of-time from which the water enters the pump, chemicals are introduced, and the waters is placed into the Dissolved Air Floatation (DAF) tank 160. Prior to introduction to the DAF dissolved air 150 is once again injected into the flow. Once in the DAF, the elapsed period-of-time allows for mixing and precipitation of desired dissolved or suspended solids before entering the DAF tank itself

According to one embodiment, immediately following the serpentine pump and before the water enters the serpentine pipes 140, exists two or more injection ports 145. These ports are, in one embodiment, placed as close as possible to the pump and designed to receive certain chemicals for the initiation of the oxidization of organics and metal salts. According to one embodiment of the present invention the chemical injection comprises a varied ratio of Hydrogen Peroxide H²O² and a pseudo form of Ferrous(II) is used comprising of Fe²SO³ aka Ferric Sulfate. The ratio of H²O² to Fe²SO³ and indeed the chemical selection itself can be continually modified based on the quality of the incoming water to optimize the coagulation and flocculation process. Moreover the amount of oxidization reagent can be also controlled resulting in a modification of the ability of water to hold solids in solution.

For example water that possess a high concentration of salt is more dense that pure water. So lowering the density of the water through the introduction of air forces the salt out of solution. Furthermore, the injection of certain chemicals can also force materials to precipitate out of the water.

According to one embodiment of the present invention, injecting Fe²SO³ combined with Hydrogen Peroxide(H²O²) as a pseudo Fenton chemistry enables the H²O² to precipitate the SO³ component and the Fee element to Fe³ (ferric chloride) so as to form a pseudo reaction or the desired chemical formation. This reaction or formulation highly oxidizes the influent water to start separation of unwanted chemical elements within the flow. This also reduces the requirement for the use of Fe³ in the precipitation chemistry for certain ion removal. The use of Fe²SO³ further creates the formation of hydra- or hydroxyl-radicals, in the water that breaks any existing emulsions. The organics within the water are iodized. In one embodiment the organisms are coalesced out while in another embodiment the organics are driven into the coagulation sludge of the serpentine mix.

One aspect of the present invention is the ability to control the introduction of specific ions at various locations of the process to cause the removal or precipitation of specific elements. Another aspect of the present invention is the ability to vary the flow and the introduction of chemicals and agents to facilitate the cleansing process dynamically. In one embodiment of the present invention the flow can be run from 25 gpm to 300 gpm without any deterioration in the quality of output. This is done by manipulating the introduction and concentration of ions into the system and by managing the coagulation and oxidization process.

A mixture of metal ions in a solution can be separated by precipitation with anions such as Cl⁻, Br, SO₄²⁻, CO₃²⁻, S²⁻, Cr₂O₄²⁻, PO₄²⁻, OH⁻ etc. When a metal ion or a group of metal ions form insoluble salts with a particular anion, they can be separated from others by precipitation. Anions can also be separated by precipitating them with appropriate metal ions.

Precipitation occur when cations and anions of aqueous solutions combine to form an insoluble ionic solid, i.e. precipitate. Whether a reaction occurs is determined by applying solubility rules for common ionic solids. According to one embodiment of the present invention a net ionic equation is established to result in an aqueous reaction resulting in select precipitation.

Recall that precipitates are insoluble ionic solid products of a reaction, in which certain cations and anions combine in an aqueous solution. The solids produced in precipitate reactions are crystalline solids and this solid can be suspended throughout the liquid or fall to the bottom of the solution. Once the crystalline solid (precipitate) is formed in the serpentine system The fluid that remains is called the supernatant liquid. The two parts (precipitate and supernate) can be separated by various methods, such as filtration, centrifuging, or decanting.

The present invention enables certain metals to be oxidized out early by an early introduction of chemicals and collected during the coalescing stage for oil and gas removal. The oil that is collected can then be refined, at which point the metals are removed harmlessly. In such a manner, heavy metals which in solution would not be acceptable as part of the discharge, can be removed and refined.

Thus, the present invention can be equally and quickly applied to varied water types with minimal alterations to the invention's configuration. Moreover, the entire system is modular and mobile meaning that the system can be transported to the location of the reclaimed water, used to clean the water and then moved to another site with water having entirely different characteristics.

Returning to FIG. 1, with the introduction of the oxidization chemistry into the water, the influent flows through a serpentine system whereupon additional chemistry can be added to enable the precipitation of the oxidized compounds, ion and cations. Along the length of the serpentine there are a plurality of further injection ports for balancing pH, precipitation and other chemical modifications to allow for the separation of undesired elements within the water flow. Before exiting the serpentine pipework an additional inlet entrains recycled water from the outlet chamber of the DAF with additional dissolved air blended into the flow to allow for air binding to the precipitated chemical which enhances flotation of the compounds targeted by the chemistry. Those elements which are not conducive to air binding will subsequently sink within the DAF to recovered by a settlement recovery system.

The dosing capability of the injection system generally comprises three further peristaltic type chemical pumps (additional to the Breaker, H²O² and FE(II) system) to allow for variable chemical modification techniques.

The serpentine injection ports also have the capability of being used for real-time monitoring of the water quality or internal changes of water chemistry. Unlike other oxidation processes of the prior art the chemical combination and mixing of the water in a serpentine takes place quickly and can be modified dynamically. As the ions are already stimulated the creation of sludge begins immediately upon chemical introduction. Indeed precipitation is already formed by the time the water leaves the serpentine minimizing the need for flocculation.

The process of water reclamation continues by flowing to a DAF Tank 160. A DAF tank is a water treatment process that clarifies waste-waters (or other waters) by the removal of suspended matter such as oil or solids. The removal is, in one embodiment, achieved by dissolving air in the water or wastewater under pressure and then releasing the air at atmospheric pressure in a flotation tank or basin. The released air forms tiny bubbles which adhere to the suspended matter causing the suspended matter to float to the surface of the water where it may then be removed by a skimming device.

In one embodiment the DAF Tank 160 comprises a large volume chamber to hold the treated influent for a specific time so as to allow the precipitated compounds to yield from the water type and mixed chemistry. The DAF tank 160 is maintained at a neutral pH to maintain safe working conditions for the operator(s) and to ensure coagulation takes place.

Another aspect of the present invention involves the injection of dissolved air into the fluid flow after the serpentine system but before entering the DAF to react with the forming (formed) precipitate. By doing so the precipitate will either float to the top of the DAF where in can be skimmed off or settle to the bottom. The DAF tank of the present invention is a combined floatation and settlement precipitation removal system. Within the DAF there are two collection systems, the first is an upper skimming system which removes the precipitated chemical blend from the surface of the water being treated that has a density less than water. This is discharged to a separate tank within the DAF chamber to allow for later dewatering in the sludge system. The second lower system, which is independent of the upper system, moves any settled or sinking precipitants to a second discharge area to be processed by the same or like sludge dewatering system as the upper skimmer.

The DAF chamber also has a weir gate at the rear discharge to allow for modifications of the outflow and to keep the combination of floated or settled solids within the DAF chamber. From the DAF chamber the treated water flows over the weir gate into the next stage of the reclamation process, an air saturation chamber 180.

The air saturation chamber 180 includes micro bubble diffusers that saturates the water with air and cocoons particles for removal. The layout and design of the diffuser units create a plurality of microbial curtains of air with managed bubble sizes. This chamber creates a microbial filter (using air) by which certain elements in the water flow cannot pass. The air yield of the diffusers is maintained to migrate these elements back into the DAF system for later extraction by the sludge recovery system(s). Based on the size of the bubble the impurities precipitate onto a bubble and are removed. This is based on the size of the bubble, and the dwell time between curtains. So by modifying the density of the water a particular molecule cannot stay in suspension and precipitates out.

The air curtain itself also contributes to managing the Chemical Oxygen Demand and the Bacterial Oxygen Demand (COD and BOD) of the effluent or cleaned water from the system. Once the water has passed through the curtain of air, it passes into the discharge chamber and into the Discharge pump. Before the Discharge Pump there is, in one embodiment, a final injection port which can be used for final modification of the effluent to meet the specified criteria desired, such as pH management, Bacterial control or other specifics.

The cleaned product is subsequently discharged to the effluent storage tank/s where it can be dispatched for reuse or for safe discharge to the environment.

Another feature of the present invention includes a sludge dewatering system. The precipitated solids from the DAF upper or lower systems are collected from respective areas by an air driven diaphragm pump. This material is pushed through a plate based press unit that is comprised of numerous chemical resistant plates aligned horizontally on a frame wherein the water/precipitates can pass into recessed chamber in the plates. These plates each have a fine mesh covering sized to allow the passage of water but not the solids. The pump moves the sludge through the press and discharges the water from the press back into the DAF tank. Upon reaching a predetermined pressure on the feed pump the unit switches off and air is purged through to drive off any residual water. Once the press has had sufficient dwell time the pressure from the plates holding them closed is released to drop out the now dry sludge cake for decanting into a suitable receptacle for safe disposal or reuse.

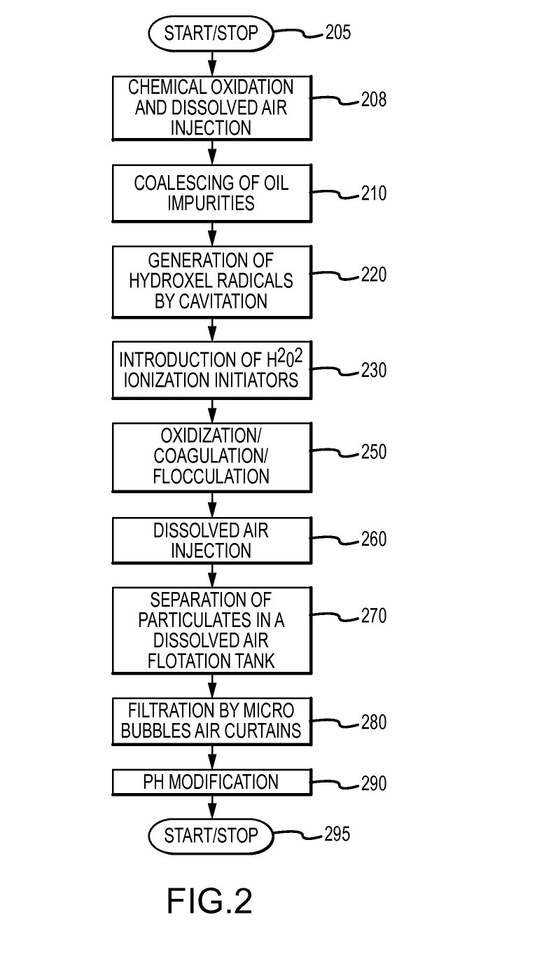

FIG. 2 depicts an examples methodology that may be used to reclaim water using H²O² and Fee SO³ induced coagulation, cavitation and oxidation according to one embodiment of the present invention. In the following description, it will be understood that each block of the flowchart illustrations, and combinations of blocks in the flowchart illustrations, can be implemented or controlled by various components including, if necessary computer programs. These computer program instructions may be loaded onto a computer or other programmable apparatus to produce a machine such that the instructions that execute on the computer or other programmable apparatus create means for implementing the functions specified in the flowchart block or blocks.

Blocks of the flowchart shown in FIG. 2 support combinations of means for performing the specified functions and combinations of steps for performing the specified functions. It will also be understood that each block of the flowchart illustrations, and combinations of blocks in the flowchart illustrations, can be implemented by special purpose hardware that perform the specified functions or steps, or combinations of special purpose hardware and its associated instructions.

A process for modular precipitation and oxidized water treatment according to one embodiment of the present invention begins 205 with the chemical oxidation of the fluid and injection of dissolved air 208. Thereafter the coalescing of oil 210 and similar impurities occurs in an oil separator. In the present invention an oil separator includes an inlet chamber, coalescing chamber or coalescing pack and an outlet weir that maintains the water level. Before introduction to the oil separator, an influent that contains dense emulsions or sediments can be mixed with an emulsion breaker. Thereafter the influent is introduced to a coalescing pack that maximizes surface area and therefore separation of oily substances. Any floatable substances are skimmed off and discharged for later use or disposal.

Other coalescing substances and techniques can be used without departing from the scope of the present invention and their use is so contemplated. In another embodiment of the present invention a recycle pump cycles additional water from a discharge chamber (described hereafter) to add dissolved air into the influent flow and enhance emulsion and floatation of oily (low density) type substances thereby effectively multiplying the surface area within the coalescing media and enhancing floatation and separation of such substances at lower temperature ranges.

The flow exits the oil separator through a cross-flow through the coalescing media to the discharge chamber and over a weir gate. The weir gate maintains influent level in the separator and collects floatable substances. The gate also prevents substances from exiting into the cavitation system or serpentine pump which can have a detrimental affect these components.

From the oil separator the influent, in one embodiment of the present invention, is introduced to a device whereby cavitation is induced to mechanically energize the fluid and remove inorganic substances while at the same time increasing the solubility of organic. Cavitation can be induced by creating turbulence or by creating a low pressure field due to increased velocity. According to the principle of the conversation of energy a fluid flow possesses a certain amount of energy. This energy can be represented as the combination of static pressure, kinetic pressure and potential energy. Assuming the flow is level the potential energy from one point to the next is equal so conservation of energy is reflected by a combination of static and dynamic pressure. As a fluid increases its speed the dynamic pressure is determined by the equation of ½pv². Thus as the velocity the dynamic component of total pressure increases by the square of its velocity. Since the total energy must be maintained the static pressure must decrease by the same amount. The result is a lower static pressure in areas of constrained or accelerated flow. As the static pressure decreases the partial pressure of a gas may be such that it no longer stays in solution. The result is an oxidative modification of the species in the aqueous medium. Oxidation products have reduced solubility and thus precipitate or co-precipitate from the aqueous medium as a gas; i.e. bubbles are formed. Oxidation can be facilitated by reactive oxygen species such as, but not limited to, hydroxyl radicals, ozone, and hydrogen peroxide. Significantly, hydroxyl radicals can be generated and added in situ by cavitation. In another embodiment of the present invention reactive oxygen species can be added to facilitate oxidation. Other oxidants that are contemplated for addition to the influent include, but are not limited to, chlorine and other halogens, hypochlorite and other hypohalite compounds, hypochlorous acid, hydroxyl radicals, inorganic peroxides, nitric acid and other nitrate compounds, sulfuric and persulfuric acids, chlorite, chlorate, perchlorate, hexavalent chromium compounds, permanganate compounds, perborate compounds, various oxide compounds, Tollen's reagent, Fenton's reagent, 2,2′-Dipyridyldisulfide (DPS).

Cavitation can also induce thermo-chemical decomposition, which can result from extremely high temperatures and pressures that are typically created where bubbles collapse during cavitation. This is why cavitation is associated with mechanical damage to surfaces subjected to cavitation such as propellers. In such an instance, the fluid near bubbles formed during cavitation can reach a critical or supercritical state, which alters the solubility of substances residing near the bubbles. Accordingly, certain inorganic substances become relatively insoluble where cavitation is abundant, and organic compounds may become more soluble. Where inorganic substances precipitate they can induce co-precipitation of otherwise relatively soluble components. For instance, precipitation of Al(III) can facilitate co-precipitation of metals such as Co(II), Ni(II), and Zn(III) from aqueous solution, where the metals are usually substantially soluble. Thus by mechanical interaction alone certain metals can be precipitated from the influent.

Post energization by one or more cavitation devices, the process of water reclamation continues by the introduction of chemicals that are mixed into the flow through a serpentine system. This mixing and serpentine configuration of pipes provides a period of time (dwell time) by which dissolved or suspended solids can precipitate or initiate precipitation 230. According to one embodiment of the present invention Hydrogen Peroxide H²O² along with a pseudo form of Ferrous(II) iron comprising Fe²SO³ or Ferric Sulfate is used. The ratio of Hydrogen Peroxide to Ferric Sulfate is, according to another embodiment of the present invention, continually monitored and adjusted to optimize coagulation and flocculation. The introduction of Ferric Sulfate further creates the formation of additional hydroxyl radicals breaking existing emulsions and facilitating precipitation. Thus organics within the water are iodized and organisms coalesce or, in another embodiment are driven to a coagulation sludge.

The present invention dynamically controls introduction of specific ions at various locations within the fluid flow to direct the removal or precipitation of specific elements. By doing so oxidation, coagulation and flocculation 250 can occur as required to remove metals or other undesirable impurities from the water. More dissolved air is injected 260 into the flow to enhance the coagulation and flocculation process and the pH of the flow is monitored and maintained.

Particulates as a result of the oxidation, coagulation and flocculation are separated 270 from the flow in a combined Dissolved Air Flotation (DAF) and settlement precipitation tank. Moreover, dissolved air is blended with the flow to enable the air to bind to the precipitated chemicals. These chemicals can then float and be skimmed off the top or, in the case of the elements that are not conducive to binding with air, removed from the bottom of the tank upon their settling.

Lastly an air saturation curtain provides a micro bubble diffuser to saturate 280 the flow with air and encapsulate particles for removal. The size of the bubbles is based on the impurity precipitate and can, according to one embodiment of the invention, be used to modify the density of the flow and thereby force a particular molecule out of suspension and to thus precipitate out. Lastly the pH of the effluent is modified 290 based on predetermined criteria or environmental standards.

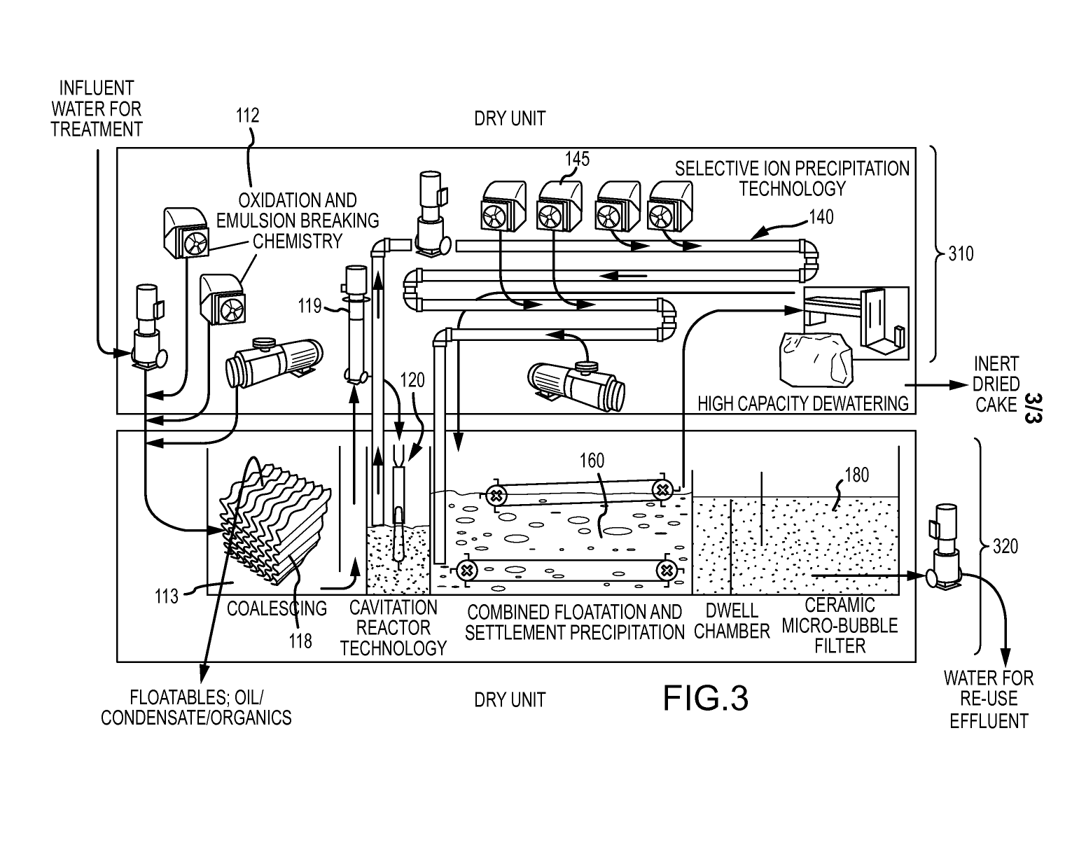

FIG. 3 presents one embodiment of a modular precipitation and oxidation water treatment system. Shown in this rendition are two modular and mobile units 310, 320 that house various treatment apparatus and components. Each of these units can be transported to a water reclamation site or location that possesses a need to remove impurities from water due to various industrial operations. As shown in FIG. 3 water first entering the system is injected with dissolved air in an oxidation process that initiates the production of hydroxyl radicals. In addition chemicals can be added to dense emulsions or sediments to aid in the breaking of the emulsified particles.

In this embodiment the oxidation and emulsion breaking injection components 112 are located on what is referred to as the “dry side” 310 of the two components modular system shown in FIGS. 3. The flow thereafter enters the “wet side” 320 of the system where oil and condensates are separated from the water. The oil separation systems 113 includes an inlet, coalescing chamber, coalescing pack and an outlet weir. A skimmer directs floatables, oil condensates and organics from the coalescing pack for disposal or reuse. The remaining fluid enters the next stage of treatment in a cavitation reactor 120.

The cavitation reactor energizes the flow using a motive pump 119 to drive the fluid through a convergent/divergent apparatus 120 that not only increases fluid flow velocity but induces turbulence in the flow. The cavitation device 120 is operable to initiate a cavitation process by which tiny bubbles are formed and collapsed. This mechanical interaction oxidizes the flow and spawns additional hydroxyl radicals. To enhance the process other reactive oxygen species such as hydroxyl radicals, ozone, and hydrogen peroxide can be added to the flow prior to the cavitation to facilitate oxidation. When the bubble collapse extremely high pressures and temperatures occur which, among other things, can alter the state and solubility of a substance. Accordingly inorganic substances can become insoluble and precipitate out of the fluid. Significantly, unlike chemically induced oxidation, the oxidation of the fluid by the cavitation system is substantially (if not completely) mechanical in nature.

The now energized fluid enters a serpentine system 140 that selectively injects ion precipitation technology. By controlling the point at which a particular ion is injected in the flow along the serpentine system, the dwell time of the ionic interaction can be controlled. Accordingly the water can be come selectively ionized to permit the coalescence of organisms and particulates.

As the flow exists the dry side 310 the flow is injected with dissolved air to enhance either the floatation or settlement characteristics of precipitates formed in the serpentine system. The DAF 160 located on the wet side receives the flow and skims off any floatation particulates or removes any sludge or settlement precipitation. Settlement precipitation is removed from the DAF and moisture is removed by a dewatering system 340 before the resulting inert dry cake is removed and disposed.

Any remaining particulates are removed by a bubble diffuser/filter 180. The diffuser controls the density of the fluid to the point that particulates simple precipitate out. Exiting the diffuser the pH of the fluid is adjusted 190 and the flow exits the system.

Presented herein by way of example is a modular precipitation and oxidation water treatment system that chemical and mechanical oxidation means by which to precipitate out unwanted impurities. This modular, transportable system uses novel techniques of coagulation, oxidation and filtration to reclaim and cleanse otherwise unusable water.

Upon reading this disclosure, those of skill in the art will appreciate still additional alternative structural and functional designs exist for a system and a process for modular precipitation and oxidized water treatment based on the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined by this disclosure.

It is also to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of, or, in-addition-to, features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A modular system for reclamation of a fluid comprising:
a cavitation reactor wherein the cavitation reactor receives an influent of the fluid and mechanically oxidizes the fluid; and
an ion precipitation system fluidly coupled to the cavitation reactor to receive the mechanically oxidized fluid and operable to selectively introduce one or more ions at one or more locations in the flow of the fluid to initiate precipitation of one or more select materials.

2. The modular system for treatment of a fluid of claim 1, wherein the cavitation reactor generates hydroxyl radicals to create a hydroxyl radical enriched fluid.

3. The modular system for treatment of a fluid of claim 1, further comprising an oxidation system operable to inject dissolved air and emulsion breaking chemistry into the fluid.

4. The modular system for treatment of a fluid of claim 3, wherein the emulsion breaking chemistry includes Ferric(II).

5. The modular system for treatment of a fluid of claim 3, wherein the emulsion breaking chemistry includes Hydrogen Peroxide.

6. The modular system for treatment of a fluid of claim 3, wherein the emulsion breaking chemistry generates Hydroxyl Radicals.

7. The modular system for treatment of a fluid of claim 3, further comprising a coalescing chamber interposed between the oxidation system and the cavitation reactor and operative separate emulsified particulates from the fluid.

8. The modular system for treatment of a fluid of claim 1, wherein the cavitation reactor precipitates inorganic substances from the fluid.

9. The modular system for treatment of a fluid of claim 1, wherein the cavitation reactor co-precipitates otherwise soluble organic substances from the fluid.

10. The modular system for treatment of a fluid of claim 1, wherein the cavitation reactor energizes the fluid.

11. The modular system for treatment of a fluid of claim 1, wherein the ion precipitation system is operable to control dwell time of the one or more ions introduced in the flow.

12. The modular system for treatment of a fluid of claim 1, further comprising an air saturation chamber operable to form a microbial filter.

13. The modular system for treatment of a fluid of claim 1, further comprising a first mobile unit and a second mobile unit wherein the first mobile unit houses an oxidation system operable to inject dissolved air and emulsion breaking chemistry into the fluid and the ion precipitation system and the second mobile unit houses a coalescing chamber operative separate emulsified particulates from the fluid interposed between the oxidation system and the cavitation reactor and wherein the fluid successively flows through the oxidation system, the coalescing chamber, the cavitation reactor, and the ion precipitation system.

14. The modular system for treatment of a fluid of claim 13, wherein the second mobile unit includes a Dissolved Air Floatation (DAF) tank and an air saturation chamber operable to form a microbial filter and wherein the fluid successively flows from the ion precipitation system to the DAF and then to the air saturation chamber.

15. A method for modular precipitation and oxidization treatment of a fluid, comprising:
receiving a flow of the fluid from a reservoir;
driving the flow through a cavitation reactor to cause the fluid to cavitate and wherein cavitation of the fluid mechanically oxidizes species in the fluid; and
injecting one or more ions at one or more locations in the flow of the fluid to initiate precipitation of one or more select materials

16. The method for modular precipitation and oxidization treatment of a fluid according to claim 15, wherein cavitation generates hydroxyl radicals in the fluid.

17. The method for modular precipitation and oxidization treatment of a fluid according to claim 15, wherein cavitation precipitates inorganic substances from the fluid.

18. The method for modular precipitation and oxidization treatment of a fluid according to claim 15, wherein cavitation co-precipitates otherwise soluble organic substances from the fluid.

19. The method for modular precipitation and oxidization treatment of a fluid according to claim 15, wherein injecting includes controlling a dwell time of the one or more ions introduced in the flow.

20. The method for modular precipitation and oxidization treatment of a fluid according to claim 15, further comprising coalescing emulsified particulates from the fluid.

21. The method for modular precipitation and oxidization treatment of a fluid according to claim 15, further comprising saturating the fluid in an air saturation chamber wherein the air saturation chamber is operable to form a microbial filter.
